(19) United States
(12) Patent Application Publication
(10) Pub. No.: US 2025/0378363 A1
(43) Pub. Date: Dec. 11, 2025

(54) Generating Matching Graphs for Decoding Qubit Errors in Quantum Error Correction Codes by Decomposing Qubit Errors

(71) Applicant: Google LLC, Mountain View, CA (US)

(72) Inventors: Austin Fowler, Los Angeles, CA (US); Craig Gidney, Goleta, CA (US)

(21) Appl. No.: 18/740,260

(22) Filed: Jun. 11, 2024

(51) Int. Cl. G06N 10/70

(52) U.S. Cl. CPC G06N 10/70

(57) ABSTRACT

A method for decoding qubit errors of a quantum computing system that implements a quantum error correction (QEC) code is disclosed. Qubits are subject to a set of error types including a set of non-decomposable error types and a set of decomposable error types. An initial matching graph (MG) is generated based on the non-decomposable error types. The initial MG includes a set of nodes and a set of non-decomposable edges. Non-decomposable edges are associated with non-decomposable error types occurring on qubits. A set of decomposable potential-edges is generated based on the decomposable error types. Decomposable potential-edges are associated with decomposable error types occurring on qubits. An updated MG is generated by applying a local-connectivity test to each decomposable potential-edge. The updated MG includes the set of nodes and a set of updated edges including the set of non-decomposable edges and a set of decomposable edges.

### FIELD

The present disclosure relates generally to quantum computing and information processing systems, and more particularly to generating matching graphs for decoding qubit errors in quantum error correction codes by decomposing local qubit errors.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b|1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to a method for decoding qubit errors on a set of qubits of a quantum computing system (QCS). The QCS implements a quantum error correction (QEC) code. The set of qubits is subject to a set of error types. The set of error types includes a set of non-decomposable error types and a set of decomposable error types. The method includes generating an initial matching graph (MG) for the QEC code based on the set of non-decomposable error types. The initial MG includes a set of nodes and a set of non-decomposable edges. Each non-decomposable edge of the set of non-decomposable edges is associated with one or more non-decomposable error types of the set of non-decomposable error types occurring on one or more qubits of the set of qubits. A set of decomposable potential-edges is generated for an updated MG. Generating the set of decomposable potential-edges is based on the set of decomposable error types. Each decomposable potential-edge of the set of decomposable potential-edges is associated with one or more decomposable error types of the set of decomposable error types occurring on one or more qubits of the set of qubits. The updated MG is generated based on the set of decomposable potential-edges. The updated MG includes the set of nodes and a set of updated edges. The set of updated edges includes the set of non-decomposable edges and a set of decomposable edges.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure;

FIG. 2A shows a surface code and a portion of a matching graph for the surface code, according to various embodiments;

FIG. 2B shows the surface code of FIG. 2A and another portion of the matching graph for the surface code, according to various embodiments;

FIG. 2C shows the surface code of FIGS. 2A-2B and an initial matching graph for the surface code, according to various embodiments;

FIG. 3A shows another surface code and an initial matching graph for the surface code, according to various embodiments;

FIG. 3B shows a portion of a first initial MG and a first decomposable potential-edge that does not pass the local-connectivity test, according to various embodiments;

FIG. 3C shows a portion of a second initial MG and a second decomposable potential-edge that does pass the local-connectivity test, according to various embodiments; and

FIG. 4 depicts a flow chart diagram of an example method for decoding qubit errors on a set of qubits of a quantum computing system (QCS).

### DETAILED DESCRIPTION

Example aspects of the present disclosure are directed to system, methods, architectures, and hardware configurations for generating a matching graph (MG). A MG may be employed for decoding qubit errors that occur during an execution of a quantum error correction (QEC) code or a quantum algorithm implementing the QEC code. The MGs of the embodiments differ from conventional MGs in that the conventional MGs include a greater number of edges and will, in general, be more “entangled” than the MGs of the embodiments. The decrease in the number of edges and the decrease in the entanglement of the MGs of the embodiments provide for more efficiency and greater accuracy/precision when decoding errors during the execution of the QEC code. For instance, decoding qubits errors via the MGs of the embodiments leads to a decrease in the logical error rate (LER) of the QEC code, as compared to the LER when a more entangled conventional MG is used in the decoding process.

More particularly, the embodiments subdivide qubit error types into a set of non-decomposable error types and a set of decomposable error types. A decomposable error type may be decomposed into two or more non-decomposable error types. After subdividing the error types into non-decomposable error types and decomposable error types, a two stage process may be performed when generating the MGs of the embodiments. In the first stage, an initial MG is generated. The initial MG includes a set of nodes and a set of non-decomposable edges. In the second stage, an updated MG is generated that includes the set of nodes, the set of non-decomposable edges, and a set of decomposable edges. The set of decomposable edges is generated by filtering a set of decomposable potential-edges. The filtering of the set of decomposable potential-edges is based on a local-connectivity test of each decomposable potential-edge, as applied on the MG. Thus, the set of decomposable edges is a subset of the set of decomposable potential-edges.

A conventional MG may include the entire set of decomposable potential-edges, whereas in the embodiments, the set of decomposable edges (e.g., included in the updated MG of the embodiments) may be a much smaller set of edges than the set of decomposable potential-edges (e.g., included in conventional MGs). As is shown below, some decomposable potential-edges generate complexity and entanglement in a conventional MG. In the embodiments, only decomposable potential-edges that do not unnecessarily increase the complexity/entanglement of the graph pass the filtering process and are included in the updated MG. The local-connectivity test provides a measure of whether any particular decomposable potential-edge will generate complexity and entanglement in the updated MG. As also shown below, decomposable potential-edges that are not included in the updated MG are somewhat redundant in that a decomposable edge may be decomposed into two or more non-decomposable edges that are already included in the updated MG. That is, these vetoed decomposable potential-edges lead to less efficiency and poorer performance when the MG is employed to decode qubit errors.

In the first stage, the initial MG is generated by considering every potential qubit error of the non-decomposable error types. Thus, the edges of the initial MG are non-decomposable edges that are associated with non-decomposable errors only. In a non-limiting example, the initial MG may include a set of disconnected subgraphs. Each subgraph of the initial MG may be associated with a separate non-decomposable error type and the nodes (e.g., each node of an MG corresponding to a detector of the QEC code or boundary of the QEC code) of each subgraph are not connected (via non-decomposable edges) to the nodes of the other subgraphs via the set of non-decomposable edges. In this sense, the subgraphs of the initial MG are disconnected or “unentangled” from one another.

In the second stage of the embodiments, the decomposable error types are considered to generate the updated MG. In this second stage, the set of decomposable potential-edges is generated by considering each possible decomposable qubit error. After generating the set of decomposable potential-edges, individual decomposable potential-edges of the set of decomposable potential-edges may be selectively added to the initial MG when the individual decomposable potential-edge does not unnecessarily increase the entanglement (or connectivity) between the subgraphs. That is, the set of decomposable potential-edges is filtered (e.g., via the local-connectivity test) to generate a set of decomposable edges that are included in the updated MG. When a decomposable potential-edge is added to the updated MG, the decomposable potential-edge becomes a decomposable edge of the updated MG. A decomposable edge may be decomposed into two or more non-decomposable edges. The two or more non-decomposable edges representing a decomposable error (or decomposable edge) may already be included in the initial MG. As such, as long as the two or more non-decomposable edges are correlated (and reweighted) to account for the decomposable error, explicitly including a decomposable potential-edge for the decomposable error in the updated MG may be unnecessary to decode the decomposable error. Thus, many decomposable potential-edges that would otherwise be included in a conventional MG are absent from the MGs of the embodiments.

A decomposable edge is added to the updated MG only when the decomposable edge passes the local-connectivity test. When the decomposable edge does not pass the local-connectivity test, the decomposable edge is not included in the updated MG. Rather, the two or more non-decomposable edges that the decomposable edge may be decomposed into are correlated via the decomposable error that leads to the decomposable edge. The correlation between the two or more non-decomposable edges may be encoded in a data structure for the MG. The data structure may additionally encode a total weight for each non-decomposable edge and each decomposable edge, as well as a list of possible candidate qubit errors associated with the edge. The weight of a particular edge may be a sum of the probability (or error rate) of each possible candidate qubit error associated with the edge. After correlating the two or more non-decomposable edges, each of the two or more non-decomposable edges may then be reweighted to account for the inclusion of decomposable error. During decoding, this correlation between the non-decomposable edges as well as the reweighting of the non-decomposable edges may be employed to infer an occurrence of a qubit error of the decomposable error type in the absence of an explicit graph edge representing the error mechanism in the MG.

More particularly, to generate the updated MG, each possible decomposable error is considered to generate a set of decomposable potential-edges. A decomposable potential-edge (for a particular qubit error) is added to the initial MG only if the decomposable potential-edge connects nodes that have already been locally-connected via the non-decomposable edges (e.g., the local-connectivity test). When a decomposable potential-edge is included in the updated MG, the decomposable potential-edge becomes a decomposable edge of the updated MG. If the decomposable potential-edge does not connect nodes that are already locally-connected, then the decomposable potential-edge is not explicitly included in the updated MG. Rather, in such cases, the decomposable potential-edge is only “implicitly” included in the updated MG by correlating and reweighting the corresponding non-decomposable edges. Correlating two or more non-decomposable edges may include listing the decomposable errors in the data structure that lists the qubit errors associated with the non-decomposable edges. Thus, after the generation of the updated MG, some of the non-decomposable edges may be associated with non-decomposable errors, as well as decomposable errors. To generate both the initial MG and the updated MG, a detector error model (DEM) for the set of qubits may be consulted.

Conventional MGs may explicitly include each possible decomposable edge (e.g., the entire set of decomposable potential-edges), as well as each possible non-decomposable edge. Including every possible edge in a conventional MG increases the entanglement and complexity of the conventional MG. In contrast, because many decomposable potential-edges are not explicitly included in the updated MG of the embodiments but are rather already represented by two or more (correlated) non-decomposable edges, the updated MGs of the embodiments do not include as many edges and are less entangled than conventional MGs. As noted above, at least some decomposable potential-edges entangle and increase the complexity of a MG. As also noted above, this may lead to an increase in efficiency when decoding qubit errors, as well as providing a reduction in LERs for the QEC code.

A QEC code may be configured to detect and correct qubit errors for each error type of a set of qubit error types based on an MG. The MG may be generated prior to the execution of the QEC code. A MG includes a set of nodes and a set of edges that connects one node of the set of nodes to at least one other node of the set of nodes. A node corresponds to a detector of a set of detectors of the QEC code or a boundary of the QEC code. The execution of the QEC code may be subdivided into a set of time-slices. Furthermore, the QEC code may form a set of logical qubits. Each logical qubit is comprised of a set of data qubits and a set of measurement qubits. A detector may represent a set of qubit measurements, (e.g., a comparison between two or more periodic measurements of a measure qubit) where each of the periodic measurements occurs at separate time-slices of the execution of the QEC code. The measurement of a measure qubit may indicate a quantum parity of data qubits associated with the measurement qubit (or the detector corresponding to the set of measurements of the data qubit). A change in the parity indicated by the measurement of the measure qubit between consecutive time-slices may indicate an error signal. Thus, when a parity is changed between consecutive time-slices, the affected detector (or corresponding node) may be labeled as a “detection event.” Thus, it may be said that a qubit error may trigger one or more detection events at one or more detectors (or one or more graph nodes).

The detectors (and thus the nodes of MG) may be arranged in layers that are stacked along a temporal axis that is discretized by the time-slices. Each layer of nodes (or detectors) corresponds to a separate time-slice and may include one or two spatial dimensions that span a line or 2D plane that the qubits (or detectors) are arranged in. Thus, an MG may be a 2D graph (e.g., for a ID QEC code such as, but not limited, to a repetition code) or a 3D graph (e.g., for a 2D QEC code such as, but not limited, to a surface code). Each qubit error may generate a detection event in a subset of the nodes. More particularly, each qubit error may generate a detection event at each detector in a subset of detectors that are affected by the qubit error. As noted above, each detector corresponds to a separate node, whereas some nodes correspond to a boundary of the QEC code. An edge connects each detector (or corresponding node) in a subset of detectors (or nodes), where a detection event is triggered in each detector (or node) in the subset of detectors (or nodes) by one or more qubit errors. Thus, each edge corresponds to one or more qubit errors (including an error type). Note that in some QEC codes, more than two detectors may correspond to a single qubit error. Thus, in some embodiments, an MG may be a hypergraph and the set of edges may include one or more hyperedges that connect more than two nodes. An MG may be a weighted graph and each edge may have a weight corresponding to a total prior probability for each qubit error corresponding to an edge.

One embodiment includes a method for decoding qubit errors on a set of qubits of a quantum computing system (QCS). The QCS implements a QEC code. The set of qubits is subject to a set of error types. The set of error types includes a set of non-decomposable error types and a set of decomposable error types. The method includes generating an initial MG for the QEC code. Generating the initial MG is based on the set of non-decomposable error types. The initial MG includes a set of nodes and a set of non-decomposable edges. Each non-decomposable edge of the set of non-decomposable edges is associated with one or more non-decomposable error types of the set of non-decomposable error types occurring on one or more qubits of the set of qubits. A set of decomposable potential-edges for an updated MG is generated. Generating the set of decomposable potential-edges is based on the set of decomposable error types. Each decomposable potential-edge of the set of decomposable potential-edges is associated with one or more decomposable error types of the set of decomposable error types occurring on one or more qubits of the set of qubits. The updated MG is then generated based on applying a local-connectivity test to each decomposable potential-edge of the set of decomposable potential-edges. The local-connectivity test is based on the initial MG. The updated MG includes the set of nodes and a set of updated edges. The set of updated edges includes the set of non-decomposable edges and a set of decomposable edges.

More particularly, when a decomposable potential-edge of the set of decomposable potential-edges passes the local-connectivity test, the decomposable potential-edge is included as a decomposable edge in the set of decomposable edges. The decomposable potential-edge passes the local-connectivity test when the decomposable potential-edge connects a subset of the set of nodes that are locally connected in the initial MG via the set of non-decomposable edges. When the decomposable potential-edge fails to pass the local-connectivity test, the decomposable potential-edge is excluded as a decomposable edge in the set of decomposable edges.

The initial MG and the updated MG are weighted graphs. The initial MG includes a set of initial weights. Each initial weight of the set of initial weights corresponds to a separate edge in the set of non-decomposable edges. The updated MG includes a set of updated weights. Each updated weight of the set of updated weights corresponds to a separate updated edge of the set of updated edges.

In some embodiments, each updated edge of the set of updated edges has an edge data structure. An edge data structure for an updated edge encodes an indication of a set of potential qubit errors associated with a subset of the set of nodes that are connected via the updated edge. An indication of a potential qubit error in the set of potential qubit errors includes a unique qubit identifier (ID) of an affected qubit of the set of qubits that is affected by the potential qubit error. The indication of the potential qubit error may additionally include an error type of the set of error types for the potential qubit error. The indication of the potential qubit error also includes a prior probability (e.g., an error rate) of the affected qubit being subject to the error type. The edge data structure may additionally encode the updated weight of the set of updated weights that corresponds to the updated edge. The updated weight may be based on the prior probability of each potential qubit error in the set of potential qubit errors for the updated edge.

When a first decomposable potential-edge can be decomposed into a first non-decomposable edge of the set of non-decomposable edges and a second non-decomposable edge of the set of non-decomposable edges and when the first decomposable edge fails to pass the local-connectivity test, a first edge data structure for the first non-decomposable edge further encodes a correlation between the first non-decomposable edge and the second non-decomposable edge. The correlation between the first non-decomposable edge and the second non-decomposable edge indicates that the first decomposable potential-edge is decomposable into the first non-decomposable edge and the second non-decomposable edge. The correlation would further indicate that the first decomposable edge failed to pass the local-connectivity test. The first edge data structure would also encode a first updated weight for the first non-decomposable edge. A second edge data structure corresponding to the second non-decomposable edge would encode similar data for the second non-decomposable edge.

In a non-limiting example, each error type of the set of error types corresponds to a separate Pauli-error type of a set of Pauli-error types. A first non-decomposable error type of the set of non-decomposable error types is a first Pauli-error type of the set of Pauli-error types. A second non-decomposable error type is a second Pauli-error type of the set of Pauli-error types. A first decomposable error type of the set of decomposable error types is a third Pauli-error type of the set of Pauli error types. In this example, the QEC code may be a topological surface code or a color code.

The set of Pauli-error types may include an X-error type (e.g., a bit-flip error in a Z-basis), a Z-type error (e.g., a phase-flip error in the Z-basis), and a Y-error type. Each of these Pauli-error types has a corresponding error operator (e.g., the Pauli matrices). Due to the commutation relations between the Pauli operators, any two of the three Pauli-error types may be chosen as a first non-decomposable error and a second non-decomposable error. The third Pauli-error type may be chosen as the first decomposable error type. For instance, a Y-error operator may be decomposed into a product of an X-error operator and a Z-error operator. Likewise, an X-error operator may be decomposed into a product of a Y-error operator and a Z-error operator. A Z-error operator may be decomposed into a product of an X-error operator and a Z-error operator. The local quantum circuits that are employed to operate stabilizers of the QEC code may dictate which two Pauli-error types are chosen as the two non-decomposable error types. In a non-limiting example, the Z-error type is selected as the first non-decomposable error type, the X-error type is selected as the second non-decomposable error type, and the Y-error type is selected as the first decomposable error type. The local quantum circuits implementing the stabilizers of the surface code may be tailored to these selections. Note that these selections may vary across the time-slices of the execution of the QEC code by changing the configurations of the local quantum-circuits across the time-slices.

Aspects of the present disclosure provide a number of technical effects and benefits. For instance, the MGs of the present embodiments differ from conventional MGs in that the conventional MGs include a greater number of edges and will, in general, be more “entangled” than the MGs of the present embodiments. The decrease in the number of edges and the decrease in the entanglement of the MGs of the present embodiments provide for more efficiency and greater accuracy/precision when decoding errors during the execution of the QEC code. For instance, decoding qubits errors via the MGs of the present embodiments leads to a decrease in the logical error rate (LER) of the QEC code, as compared to the LER when a more entangled conventional MG is used in the decoding process.

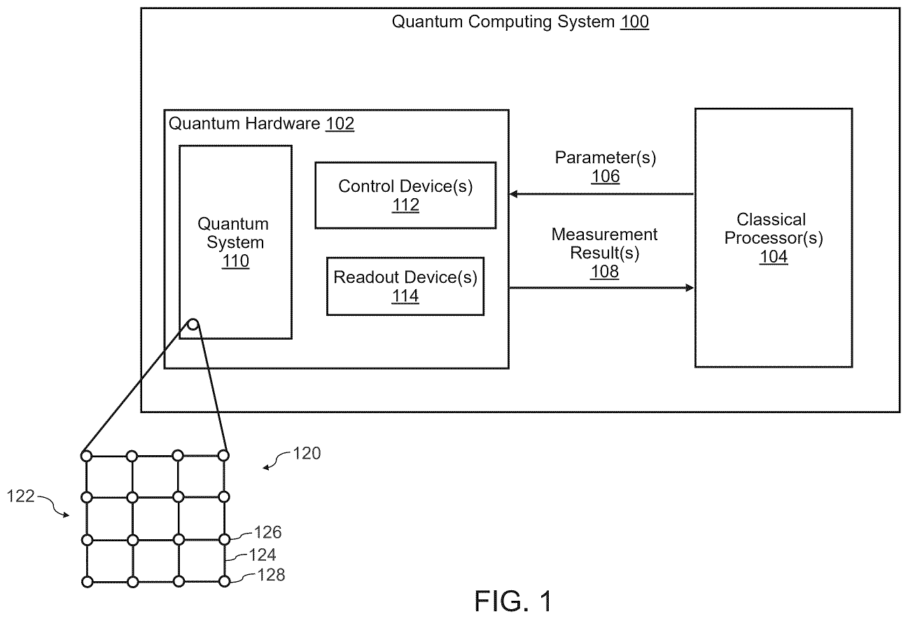

FIG. 1 depicts an example quantum computing system 100. The system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 100 includes quantum hardware 102 in data communication with one or more classical processors 104. The classical processors 104 can be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots, or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit, and the control device(s) 112 and readout devices(s) 114 may implement one or more quantum logic gates that operate on the quantum hardware 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameters 106 from the classical processors 104. The quantum hardware 102 may use the received physical control qubit parameters 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 can take advantage of a difference in the impedance for the |0 [symbol] and |1 [symbol] states of an element of the quantum system 110, such as a qubit, to measure the state of the element (e.g., the qubit). For example, the resonance frequency of a readout resonator can take on different values when a qubit is in the state |0 [symbol] or the state |1 [symbol] , due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1 includes 4×4 qubits, however in some implementations the quantum system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed.

FIG. 1 depicts one example quantum computing system that can be used to implement the methods and operations according to example aspects of the present disclosure. Other quantum computing systems can be used without deviating from the scope of the present disclosure.

### Matching Graphs for Quantum Error Correction Codes

As indicated above, the embodiments are directed to methods, architectures, and hardware configurations for generating a matching graph (MG). A MG may be employed for decoding qubit errors that occur during an execution of a quantum error correction (QEC) code or a quantum algorithm implementing the QEC code. The MGs of the embodiments differ from conventional MGs in that the conventional MGs include a greater number of edges and will, in general, be more “entangled” than the MGs of the embodiments. The decrease in the number of edges and the decrease in the entanglement of the MGs of the embodiments provide for more efficiency and greater accuracy/precision when decoding errors during the execution of the QEC code. For instance, decoding qubits errors via the MGs of the embodiments leads to a decrease in the logical error rate (LER) of the QEC code, as compared to the LER when a more entangled conventional MG is used in the decoding process.

More particularly, the embodiments subdivide qubit error types into a set of non-decomposable error types and a set of decomposable error types. A decomposable error type may be decomposed into two or more non-decomposable error types. After subdividing the error types into non-decomposable error types and decomposable error types, a two stage process is performed when generating the MGs of the embodiments. In the first stage, an initial MG is generated. The initial MG includes a set of nodes and a set of non-decomposable edges. In the second stage, a set of decomposable potential-edges is generated. After generating the set of decomposable potential-edges, an updated MG is generated that includes the set of nodes, the set of non-decomposable edges, and a set of decomposable edges. The set of decomposable edges is generated by filtering the set of decomposable potential-edges. The filtering of the set of decomposable potential-edges is based on a local-connectivity test of each decomposable potential-edge, as applied on the initial MG as it is being updated. Thus, the set of decomposable edges is a subset of the set of decomposable potential-edges.

A conventional MG may include the entire set of decomposable potential-edges, whereas in the embodiments, the set of decomposable edges (e.g., included in the updated MG of the embodiments) may be a much smaller subset of edges, as compared to the set of decomposable potential-edges (e.g., included in conventional MGs). Some decomposable potential-edges generate complexity and entanglement in a conventional MG. In some embodiments, only decomposable potential-edges that do not unnecessarily increase the complexity/entanglement of the updated MG pass the filtering process and are included in the updated MG. The local-connectivity test provides a measure of whether any particular decomposable potential-edge will generate complexity and entanglement in the updated MG. Decomposable potential-edges that are not included in the updated MG may be redundant in that a decomposable edge may be decomposed into two or more non-decomposable edges that are already included in the updated MG. That is, these vetoed decomposable potential-edges lead to less efficiency and poorer performance when the MG is employed to decode qubit errors.

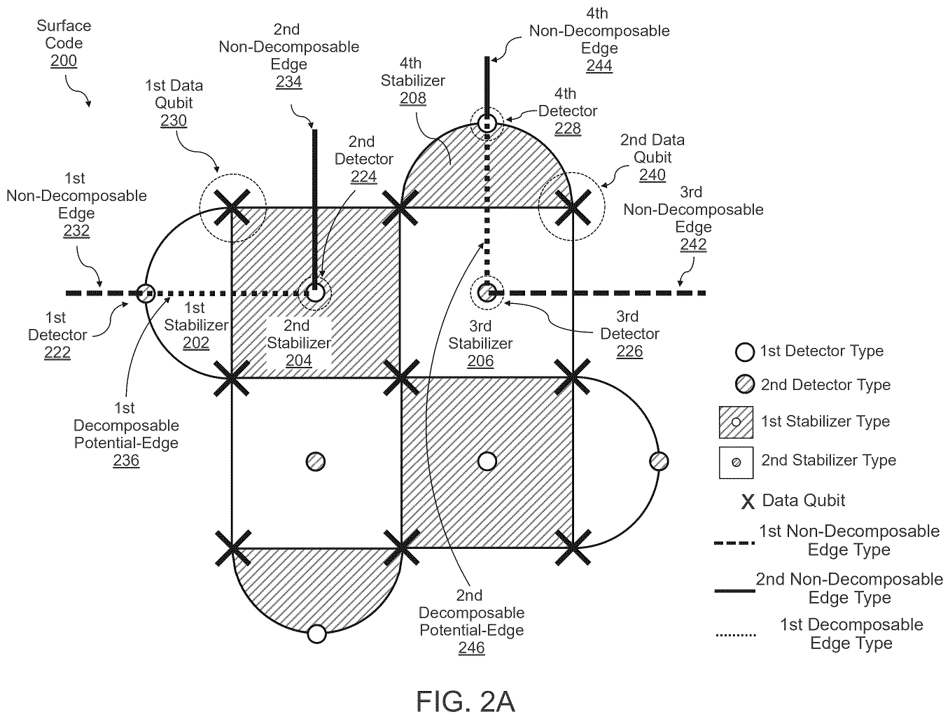

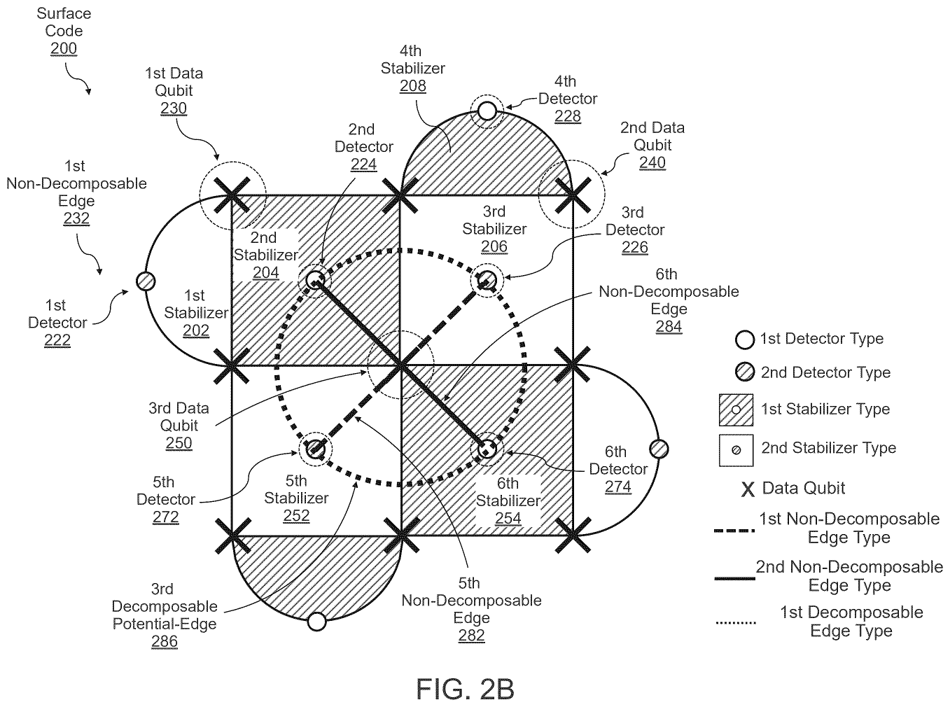

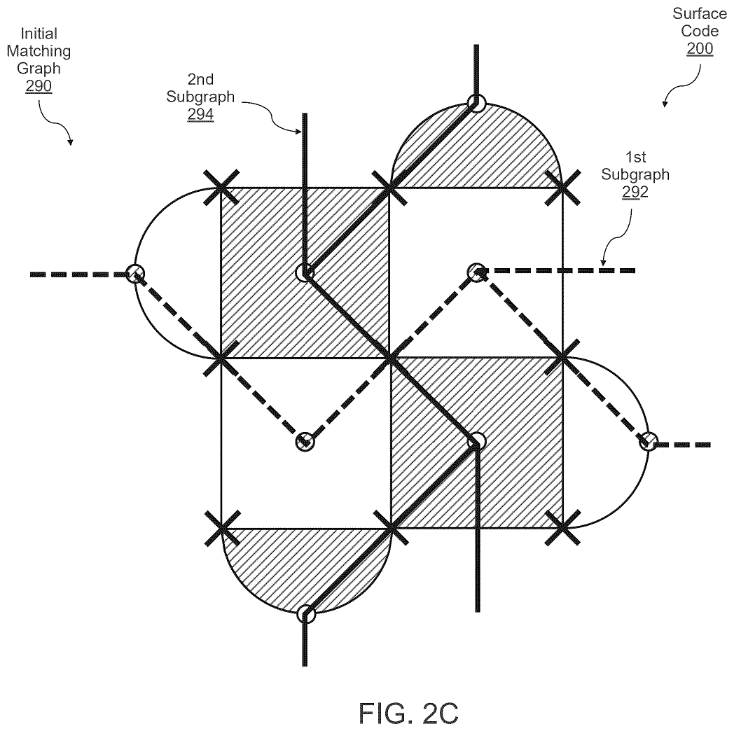

FIG. 2A shows a surface code 200 and a portion of a matching graph for the surface code 200, according to various embodiments. It is noted that the surface code 200 and its corresponding partial matching graph are provided as an example only and the present embodiments are not limited to surface codes. In addition to topological surface codes, the embodiments are applicable to other quantum error correction (QEC) codes, such as but not limited to color codes, repetition codes, and the like. Surface code 200 has a distance of d=3. Surface code 200 is a non-limiting example and the embodiments contemplate other surface codes (e.g., surface codes with a distance greater than three).

Surface code 200 is implemented via a set of qubits (e.g., included in a quantum computing system). The plane of FIG. 2A is a spatial plane and includes two spatial dimensions. As discussed throughout, the execution of the surface code 200 generates a temporal dimension, with a temporal axis extending in a direction orthogonal to the plane of FIG. 2A. The execution of the surface code 200 is discretized into time-slices. The temporal axis may then be discretized by the time-slices. The set of qubits includes a set of data qubits and a set of measure qubits. In FIG. 2A, the data qubits are indicated by an “X” icon, e.g., first data qubit 230 and second data qubit 240. During the execution of the surface code 200 (or a quantum algorithm that implements the surface code 200), the measure qubits are periodically measured (e.g., at the time-slices) and are located at the locations that include shaded and unshaded smaller circles. The periodic measurements of the measure qubits provide detectors for the surface code and are discussed below. However, briefly here, a detector includes a set of qubit measurements, e.g., a set of measure qubit measurements. A detector may include a comparison for two or more measurements of a measure qubit in consecutive time-slices. In FIG. 2A, the detectors are co-located with the measure qubits and are indicated as the shaded and unshaded smaller circles. Thus, the set of qubits, including the set of data qubits and the set of measure qubits are arranged in a discretized grid lying in the plane of FIG. 2A.

Surface code 200 includes a set of stabilizers. Each stabilizer of the set of stabilizers is associated with a quantum operator (e.g., implemented by a quantum circuit). In surface code 200, there are two types of stabilizers, with each type being associated with a different quantum operator type. Each of the two types of stabilizers detects a separate quantum error type (or error mechanism or error process) depending on the operator type (e.g., as dependent on the implementing quantum circuits) associated with the stabilizer. Stabilizers of the first type are shown via the shaded squares/semicircles and stabilizers of the second type are shown via the unshaded squares/semicircles. The first stabilizer 202 and the third stabilizer 206 are of the second stabilizer type. The second stabilizer 204 and the fourth stabilizer 208 are of the first stabilizer type.

Each stabilizer has a measure qubit located at its “center.” Because in FIG. 2A, the measure qubits are co-located with the detectors, the measure qubits are not shown explicitly in FIG. 2A. The measurements of the measure qubits are referred to as detectors shown via the unshaded and shaded smaller circles. In some embodiments, a detector includes a set of measurements on a particular measure qubit across two or more time-slices of executing the surface code 200. For instance, a detector may compare a current measurement of the measure qubit to a measurement of the measure qubit in the previous time-slice. There are two types of detectors, the first type of detector shown as the unshaded circles and the second type of detector shown as the shaded circles. Note that the detectors are periodic in the temporal dimension and FIG. 2A shows a single time-slice of the detectors (e.g., one set of detectors associated with a single time-slice of the execution of the surface code 200). As noted above, the plane of FIG. 2A shows the two spatial dimensions that the set of qubits are arranged over. The first stabilizer type (shown as shaded squares/semicircles) is associated with the first detector type (shown as unshaded circles). The second stabilizer type (shown as unshaded squares/semicircles) is associated with the second detector type (shown as shaded circles). Thus, in the single time-slice shown in FIG. 2A, the first stabilizer 202 is associated with a first detector 222 (of the first detector type), the second stabilizer 204 is associated with a second detector 224 (of the second detector type), the third stabilizer 206 is associated with a third detector 226 (of the first detector type), and the fourth stabilizer 208 is associated with a fourth detector 228 (of the second detector type).

The detectors occur in layers, where a particular layer occurs at a particular time-slice of the execution of the surface code 200. Thus, during the execution of the surface code 200, layers of detectors occur, where the layers are stacked in a direction that is perpendicular to the plane of FIG. 2A. That is, the temporal axis of FIG. 2A extends perpendicular to the two spatial dimensions of FIG. 2A. In some embodiments, the two types of detectors occur at alternating time-slices. For instance, measure qubits of the first stabilizer type are measured at a first and a third time-slice, while measure qubits of the second stabilizer type are measured at a second and a fourth time-slice. For simplicity, in FIG. 2A, detectors of both types are shown in a common time-slice.

As shown in FIG. 2A, each “square” stabilizer has four data qubits (e.g., one at each of the four corners of the square) and a measure qubit at the center of the square. Each semicircle stabilizer (located on boundaries of the surface code 200) has two data qubits located at two antipodal points on the diameter of the semicircle and a measure qubit located at a “center” of the “arc” of the semicircle. The operator of a stabilizer is associated with quantum operations on the data qubits of the stabilizer. For a surface code to be valid, the operator of a stabilizer must commute with the operators of each other stabilizer in the code. More particularly, the operator of a stabilizer is associated with error mechanisms on the data qubits of the stabilizer. Each error mechanism (or error type) is associated with a Hermitian operator. Some error types may be “non-decomposable,” while other error types may be “decomposable.”

A decomposable error type may be an error type where the operator of the error type is composed of a product of the operators of two or more non-decomposable error types.

In some embodiments, the quantum error types (or error mechanisms) of the qubits are assumed to be Pauli-error types. Thus, X-type errors (e.g., bit-flip errors), Z-type errors (e.g., phase-flip errors), and Y-type errors are assumed to be the error types detectable and correctable by the surface code 200. X-type errors are associated with the Pauli-X operator, Z-type errors are associated with the Pauli-Z operator, and Y-type errors are associated with the Pauli-Y operator, all of which are Hermitian operators.

A quantum state of an isolated qubit that is not entangled with anything else may be represented as a point in a Bloch sphere. More particularly, in the Bloch-sphere model (BSM) of the representation of a quantum state of an unentangled qubit, an X-error is associated with a π rotation about the Bloch sphere's X-axis, a Z-error is associated with a π rotation about the Bloch sphere's Z-axis, and a Y-error is associated with a n rotation about the Bloch sphere's Y-axis. That is, if the eigenstates of the Pauli-Z operator are denoted as |0 [symbol] and |1 [symbol] (e.g., the Z-basis eigenstates), then a Pauli-X operator (e.g., an X-error) is associated with the transformation |0 [symbol] ⇔|1 [symbol] (e.g., a π rotation about the X-axis). This is why X-errors may be referred to as bit-flip errors. Likewise, if the eigenstates of the Pauli-X operator are denoted as

$$\vert + 〉 = \frac{1}{\sqrt{2}} ( \vert 0 〉 + \vert 1 〉 ) and \vert - 〉 = \frac{1}{\sqrt{2}} ( \vert 0 〉 - \vert 1 〉 )$$

(e.g., the X-basis eigenstates), then a Pauli-Z operator is associated with the transformation |+ [symbol] ⇔|− [symbol] (e.g., a π rotation about the Z-axis). This is why Z-errors may be referred to as phase-flip errors. For completeness, the eigenstates of the Pauli-Y operator may be denoted as

$$\vert i 〉 = \frac{1}{\sqrt{2}} ( \vert 0 〉 + i \vert 1 〉 ) and \vert - i 〉 = \frac{1}{\sqrt{2}} ( \vert 0 〉 - i \vert 1 〉 )$$

(e.g., the Y-basis eigenstates). Y-errors are associated with a It rotation about the Y-axis of the Bloch sphere representation of the quantum state of a qubit.

As shown via the commutation relationships of the Pauli operators, any two of the three Pauli operators may be taken as non-decomposable (or fundamental) operators, and the third operator is a decomposable operator. For instance, the X operator and the Z operator may be taken as non-decomposable operators and the Y operator is a decomposable operator since it can be formed by the product of the X operator and the Z operator (e.g., the Y operator can be decomposed into the X operator and the Z operator). In such embodiments, X-errors and Z-errors are non-decomposable errors and Y-errors are decomposable errors because Y-errors are decomposable into X-errors and Z-errors. In other embodiments, X-errors and Y-errors are non-decomposable errors and Z-errors are decomposable errors because Z-errors are decomposable into X-errors and Y-errors. In some embodiments, Y-errors and Z-errors are non-decomposable errors and X-errors are decomposable errors because X-errors are decomposable into Y-errors and Z-errors.

Note that the embodiments are not limited to Pauli errors, and a QEC code may take into account additional and/or alternative error types (e.g., multi-qubit errors such as but not limited to cross-talk errors and the like). Whatever error types are accounted for in a QEC code, the error types can be subdivided into non-decomposable errors and decomposable errors. Whether an error type is a decomposable error type or a non-decomposable error type may be dependent on the details of the particular QEC code, e.g., the quantum circuits that are employed to form the stabilizers.

In the non-limiting example of FIG. 2A, surface code 200 is configured to detect (and correct) qubit errors of a first non-decomposable error type, a second non-decomposable error type, and a first decomposable error type. As noted above, the surface code 200 is a non-limiting example and in some embodiments, other QEC codes are configured to detect additional non-decomposable errors and/or additional decomposable error types. The first non-decomposable error type is associated with a first error operator, the second non-decomposable error type is associated with a second error operator, and the first decomposable error type is associated with a third error operator. As indicated above, the third error operator may be decomposed into (a product of) the first error operator and the second error operator. Each of the three error operators may anticommute (up to multiplicative factor) with each of the other two error operators.

As noted above, a stabilizer is associated with an error operator type (e.g., a Pauli operator type). The stabilizer's operator is composed of an error operator (of a given error type) for each of the stabilizer's data qubits. In general, a stabilizer is configured to detect an error type in its qubits if the error operator of the error type anti-commutes with the stabilizer's operator. Thus, due to this anti-commuting requirement, a stabilizer is configured to detect an error in one or more of its qubits if the operator associated with error type of the detectable error anti-commutes with the operator type of the stabilizer's operator. Accordingly, the error type of the stabilizer's operator must be different from the error type that the operator is configured to detect. More particularly, the first stabilizer type of surface code 200 (e.g., the second stabilizer 204 and the fourth stabilizer 208) is configured to detect a second non-decomposable error type and the second stabilizer type of surface code 200 (e.g., the first stabilizer 202 and the third stabilizer 206) is configured to detect a first non-decomposable error type via the associated detectors (e.g., measurements of the stabilizer's measure qubit). A decomposable error type may be detected via a combination of the first stabilizer type and the second stabilizer type. As noted above, each of the stabilizer operators must commute with each other stabilizer operator

In the non-limiting embodiment of surface code 200, the first non-decomposable error type may be a Z-error (e.g., a phase-flip error), the second non-decomposable error type may be an X-error (e.g., a bit-flip error), and the first decomposable error type may be a Y-error (e.g., decomposable into an X-error and a Z-error). Note that this is a non-limiting example, and as indicated above, any two of the three Pauli-error types can be the first and second non-decomposable error type and the third Pauli-error type is the decomposable error. Also note that the choice for non-decomposable error types and the decomposable error type may vary across the time-slices of the execution of the surface code 200. In this non-limiting example, the first stabilizer type (e.g., the second stabilizer 204 and the fourth stabilizer 208) is a Z-type stabilizer that detects X-type errors. The second stabilizer type (e.g., the first stabilizer 202 and the third stabilizer 206) is an X-type stabilizer and detects Z-type errors. The decomposable Y-errors are detected via a combination of a X-type stabilizer and a Z-type stabilizer.

In this non-limiting example, the operator of the first stabilizer 202 (e.g, the second stabilizer type) is “XX,” where each X represents a Pauli-X operator, one for each of the two data qubits of the first stabilizer 202. The operator of the third stabilizer 206 (e.g., the second stabilizer type) is “XXXX,” where each of the four Pauli-X operators is assigned to one of the four data qubits of the third stabilizer 206. Due to the anti-commuting requirement between the stabilizer's operator and the error operator of the type of errors that a stabilizer is configured to detect, the first stabilizer 202 and the third stabilizer 206 (e.g., X-type stabilizers) are configured to detect Z-errors and Y-errors in the stabilizers' qubits. The operator of the second stabilizer 204 (e.g., the first stabilizer type) is “ZZZZ,” where each Z represents a Pauli-Z operator, one for each of the four data qubits of the second stabilizer 204. The operator of the fourth stabilizer 208 (e.g., the first stabilizer type) is “ZZ,” where each of the two Pauli-Z operators is assigned to one of the two data qubits of the fourth stabilizer 208. Due to the anti-commuting requirement between the stabilizer's operator and the error operator of the type of errors that a stabilizer is configured to detect, the second stabilizer 204 and the third stabilizer 206 (e.g., Z-type stabilizers) are configured to detect X-errors and Y-errors in the stabilizers' qubits. Thus, in this non-limiting embodiment, the first stabilizer type is a Z-stabilizer type and the second non-decomposable error type is an X-error (e.g., a bit-flip error). The second stabilizer type is an X-stabilizer type and the first non-decomposable error type is a Z-error (e.g., a phase-flip error). The first decomposable error type is a Y-error.

Note that because the first stabilizer 202 (e.g., an X-type stabilizer) and the second stabilizer 204 (e.g., a Z-type stabilizer) share an even number (e.g., two) of data qubits, and the fact that X and Z operators anticommute, the operator of the first stabilizer 202 commutes with the operator of the second stabilizer 204, which is a requirement for a valid QEC code. Likewise, because the third stabilizer 206 (e.g., an X-type stabilizer) and the fourth stabilizer 208 (e.g., a Z-type stabilizer) share an even number (e.g., two) of data qubits, and the fact that X and Z operators anticommute, the operator of the third stabilizer 206 commutes with the operator of the fourth stabilizer 208. Also because the second stabilizer 204 (a Z-type stabilizer) and the third stabilizer 206 (e.g., an X-type stabilizer) share an even number (e.g., two) of data qubits, the operator of the second stabilizer 204 commutes with the operator of the third stabilizer 206. Because the first stabilizer 202 and the fourth stabilizer 208 share an even number (e.g., zero) of data qubits, the operator of the first stabilizer 202 and the operator of the fourth stabilizer 208 commute because they are not operating on data qubits that are common to the two stabilizers. In general, because error operators of different types anticommute, when stabilizers of different types share an even number of data qubits, the operators of the stabilizers commute. An inspection of the surface code 200 shows this is true of any pair of stabilizers. That is, a stabilizer pair that includes the first stabilizer type and the second stabilizer type and shares an even number of data qubits will commute. Also, the operators of a stabilizer pair that includes two stabilizers of the same stabilizer type commute because error operators of the same type commute.

In the execution of surface code 200, local quantum circuits are employed such that, for a given stabilizer, and prior to a measurement of the stabilizer's measure qubit at a given time-slice, the measure qubit is prepared in a quantum state that indicates a parity associated with the stabilizer's data qubits. The measurement of the measure qubit (at the given time-slice) is used to infer the parity of the stabilizer's data qubits. An error is detected when an unexpected value of the parity of the stabilizer's data qubits is observed via the measurement of the stabilizer's measure qubit. For instance, when the data qubits are being employed as quantum memory that implements surface code 200, when the parity of the data qubits (of a particular stabilizer) is switched between two consecutive measurements of the particular stabilizer's measure qubit, then an error may have occurred in at least one of the stabilizer's (data or measure) qubits between the two consecutive measurements. In a similar way, when the data qubits are being employed in quantum logic operations of a quantum algorithm (e.g., a quantum algorithm that implements surface code 200), an unexpected parity value (at a particular time-slice of the execution of the quantum algorithm) indicates an error occurred in at least one of the stabilizer's (data or measure) qubits.

Because qubits are subject to multiple error types (or error mechanisms or error processes), multiple parity types must be accounted for in a valid QEC code. In general, the different types of stabilizers are configured to observe different parities (of the stabilizer's data qubits), where each of the different parities is associated with a different non-decomposable error type. In surface code 200, the first stabilizer type is configured to measure a first parity type of its data qubits. The first parity type is associated with the first non-decomposable error type (and its corresponding error operator). The second stabilizer type is configured to measure a second parity type of its data qubits. The second parity type is associated with the second non-decomposable error type (and its corresponding error operator). In this sense, the configurations of the stabilizers (and the local quantum circuits that implement the stabilizers) may determine which error types are non-decomposable error types and which error types are decomposable error types.

In the above non-limiting example, where the first stabilizer type (e.g., the second stabilizer 204 and the fourth stabilizer 208) is a Z-stabilizer, the first non-decomposable error type is a Z-error (e.g., a phase-flip error), the second stabilizer type is an X-stabilizer, and the second non-decomposable error type is an X-error (e.g., a bit-flip error), then the first parity type is a Z-type parity and the second parity type is an X-type parity. The X-type parity (associated with the second stabilizer type) is associated with an X-error and a Pauli-X operator. The Z-type parity (associated with the first stabilizer type) is associated with a Z-error and a Pauli-Z operator. However, due to the anti-commutative requirement, X-type stabilizers are configured to detect Z-type (non-decomposable) errors and Y-type (decomposable) errors, while Z-type stabilizers are configured to detect X-type (non-decomposable) errors and Y-type (decomposable) errors.

As noted above, a stabilizer is configured to detect an error type in its qubits if the error operator of the error type anti-commutes with the stabilizer's operator. Because the stabilizer operator of the second stabilizer type includes Pauli-X operators, and a Pauli-X operator anti-commutes with Pauli-Z and Pauli-Y operators, the second stabilizer type (e.g., the first stabilizer 202 and the third stabilizer 206) is configured to detect Z-type errors and Y-type errors. Likewise, because the stabilizer operator of the first stabilizer type includes Pauli-Z operators, and a Pauli-Z operator anti-commutes with Pauli-X and Pauli-Y operators, the first stabilizer type (e.g., the second stabilizer 204 and the fourth stabilizer 208) is configured to detect X-type errors. Two (or more) stabilizers of opposite types (e.g., one X-type stabilizer and one Z-type stabilizer) may be employed to detect decomposable error types (e.g., Y-type errors). In general, the first stabilizer type is configured to detect the second non-decomposable error type and the second stabilizer type is configured to detect the first non-decomposable error type. Combinations of the first and second stabilizer types may be employed to detect decomposable errors.

As noted above, each detector corresponds to a measurement of a measure qubit. As also noted above, at each time-slice of the execution of the surface code 200, a layer of detector observations is generated (e.g., via the measurements of the measure qubits at that time-slice). The layers of detectors are stacked along the discretized time-slices of a temporal axis that is orthogonal to the plane of FIG. 2A. During the execution of the surface code 200 (whether the qubits are being used for quantum memory or quantum logic operations), when an unexpected parity measurement (e.g., either an X-type parity measurement or a Z-type parity measurement) is observed, the corresponding detector is labeled as a “detection event.” Detection events are signals and/or indications of qubit errors. More particularly, a pattern of correlated detection events provides a signal of one or more possible qubit error types occurring on one or more qubits.

In the surface code 200, each qubit error results in 0-4 detection events. Thus, during the execution of the surface code 200, multiple sets of detection events are observed. Because each time-slice generates a new layer of detector observations, each time-slice generates a new layer or set of detector events. Note that in the absence of qubit errors, the corresponding layer of detectors has no detector events (e.g., the new layer or set of detection events is an empty set). Thus, during the execution of the surface code 200, detector observations (and thus detection events) are received via a stream of data. The stream of data may be referred to as an error signal stream, where the temporal dimension of the data stream is discretized by the time-slices of the execution of the surface code 200. That is, detection events may arrive in discretized packets in the error signal stream, where each packet of detector events may correspond to a time-slice of the execution of the surface code 200. Note that in the absence of errors, a particular packet in the error signal stream (corresponding to a particular time-slice) may be an empty packet.

Each individual detection event provides some evidence that one or more error types have occurred in one or more qubits “local” to the corresponding detector (or stabilizer that includes the detector). Determining which error types likely occurred and/or which qubits are likely affected by an error is referred to as decoding the error signal stream. To detect and correct qubit errors during the execution of the surface code 200, decoding based on the error signal stream must be performed in real-time during the execution. Because a single qubit error can result in multiple detection events, decoding requires correlating (or grouping) detection events in the error signal stream based on the likelihood of various errors occurring.

Furthermore, a single detection event can indicate multiple error types and/or affected qubits. Thus, decoding in real-time is a computationally complex problem. To assist in decoding, a matching graph (for the QEC code or a quantum algorithm that implements the QEC code) may be generated prior to the execution of the QEC code and/or the quantum algorithm that implements the QEC code.

FIG. 2A shows a portion of a matching graph for surface code 200. The set of detectors and the set of boundaries of the QEC code serve as a set of nodes for the matching graph. As noted throughout, FIG. 2A shows only a single layer of detectors. However, the entire set of detectors (and nodes), which includes a layer of detectors (and nodes) at each time-slice of the execution of the surface code 200 (or the quantum algorithm that implements the surface code 200), may be generated prior to the execution. The matching graph includes a set of edges, which may also be generated prior to the execution. In some embodiments, the generation of the matching graph, including the generation of the set of detectors (e.g., nodes of the matching graph) and the generation of the set of edges, is done offline (e.g., prior to the QEC code's execution). In some embodiments, the generation of the matching graph is a classical computation task performed by one or more classical processor devices. The one or more classical processor devices may be, but need not be, included in a quantum computing system (QCS).

The generation of a matching graph may be based on a detector error model (DEM). A DEM may be encoded in a classical data structure. The DEM may include, for each qubit of the set of qubits, an entry (or data record) for each qubit of the set of qubits. An entry (or record) for a qubit in the DEM may indicate each error type (or error mechanism) that the qubit is subject to. Note for multiple qubit error types (e.g., qubit cross-talk), the DEM may include a similar entry for each possible multiple qubit groupings. In addition to indicating each error type a qubit (or multiple qubit grouping) is subject to, a qubit's entry (or multiple qubit grouping's entry) in the DEM may indicate a prior probability for that error type occurring in that qubit. That is, the DEM encodes the likelihood or prior probability for each qubit experiencing each possible qubit error type.

Each edge in the set of edges connects a detector (e.g., a node) to one or more other detectors (e.g., another node), or a boundary of the QEC code (e.g., or another node). Two detectors are connected by an edge if detection events occurring at each of the two detectors may be correlated via a common qubit error. For instance, when a qubit error (or a particular error type) triggers detection events at two different detectors, those two detectors may be connected via an edge of the matching graph. Because a qubit error can result in 0-4 detection events, some edges may be hyperedges that connect the three or four corresponding detectors. Note that in other embodiments, single or multiple qubit errors may result in a greater number of detection events that may be connected via a hyperedge. Thus, a matching graph may be a hypergraph. When a qubit error generates two detection events, an edge is generated that connects the corresponding two detectors. When a qubit error generates a single detection event, an edge may connect the corresponding detector to a boundary of the QEC code.

In addition to connecting detectors (or a detector to a QEC boundary), each edge may include a data structure that encodes a weight for the edge. That is, each edge may have an edge data structure (or edge data object). That is, a matching graph may be a weighted graph encoded in a weighted graph data structure. In addition to encoding a weight for the edge, the data structure (or data object) for an edge (e.g., the edge data structure) may include an indication of each error mechanism (e.g., including which error type(s) and which affected qubit(s)) that is associated with the edge. Note that some edges may be “degenerate” in the sense that a single edge may be associated with more than one qubit error (one or more error types affecting one or more qubits). That is, the detection events connected via an edge could have been triggered by more than one error type and/or more than one qubit error. Thus, each edge is associated with one or more qubit errors. The association between an edge and the one or more qubit errors (including error types) that could have triggered the one or more detection events that correspond to the one or more detectors that are connected by the edge. During the generation of a matching graph, the DEM may be consulted to determine each possible qubit error and which detectors are triggered with a detection event. For each qubit error, the edge's data structure may indicate a prior probability for that error occurring. The DEM may be consulted for determining the prior probability for each possible qubit error (including the error type and/or error mechanism). The weight of the edge may be based on a sum of the prior probabilities for all the qubit errors associated with the edge. Again, the DEM may be consulted to obtain the prior probabilities associated with each possible qubit error.

In some embodiments, an edge may correspond to a single error type (e.g., the first non-decomposable error type, the second non-decomposable error type, or the first decomposable error type). For instance, a matching graph may include a first non-decomposable edge type, a second non-decomposable edge type, and a first decomposable edge type. Thus, edges may be classified as non-decomposable edges and decomposable edges. In the above non-limiting example, the first non-decomposable edge type may be associated with the first non-decomposable error type. The second non-decomposable edge type may be associated with the second non-decomposable error type. The first decomposable edge type may be associated with the first decomposable error type. In some embodiments, the first non-decomposable edge type may be associated with Z-errors, the second non-decomposable edge type may be associated with X-errors, and the first decomposable edge type may be associated with Y-errors.

The incomplete matching graph of FIG. 2A shows a first non-decomposable edge 232, a second non-decomposable edge 234, a third non-decomposable edge 242, a fourth non-decomposable edge, a first decomposable potential-edge 236, and a second decomposable potential-edge 246. The first non-decomposable edge 232 and the third non-decomposable edge 242 are of the first non-decomposable edge type and are thus associated with the first non-decomposable error type, which in the above non-limiting example is Z-errors. The second non-decomposable edge 234 and the fourth non-decomposable edge 244 are of the second non-decomposable edge type and are thus associated with the second non-decomposable error type, which in the above non-limiting example is X-errors. The first decomposable potential-edge 236 and the second decomposable potential-edge 246 are of the first decomposable edge type and are thus associated with the first decomposable error type, which in the above non-limiting example is Y-errors. Note that in addition to more edges (and perhaps more edge types) located in the plane of FIG. 2A, the complete matching graph would have additional layers of detectors with connections between detectors or the same layer and connections between different layers, which are stacked along the temporal axis orthogonal to the plane of FIG. 2A. Also note that the first decomposable potential-edge 236 and the second decomposable potential-edge 246 are potential-edges and are only added to an updated MG of the embodiments if the potential-edge passes a local-connectivity test, as described below.

By way of example only, because the first data qubit 230 is included in the first stabilizer 202 (which is an X-type stabilizer) a Z-error in the first data qubit 230 (occurring prior to the time-slice of FIG. 2A) may generate a detection event at the first detector 222. Because the first data qubit 230 is not included in any other X-type stabilizers, a Z-error in the first data qubit 230 will only trigger a detection event in the first detector 222 and no other detectors in the matching graph. As such, the first non-decomposable edge connects the first detector 222 to a boundary of the surface code 200. An edge data structure for the first non-decomposable edge 232 has an entry for a Z-error in the first data qubit 230. The prior probability for a Z-error in the first data qubit 230 may be included in the edge data structure for the first non-decomposable edge 232. Note that other qubit errors may also trigger a detection event only in the first detector 222 (and no other detectors). These other qubit errors may have entries in the edge data structure for the first non-decomposable edge 232. The weight of the first non-decomposable edge 232 may be based on the sum of the probabilities for all errors associated with the first non-decomposable edge 232.

Because the first data qubit 230 is included in the second stabilizer 204 (which is a Z-type stabilizer) an X-error in the first data qubit 230 (occurring prior to the time-slice of FIG. 2A) may generate a detection event at the second detector 204. Because the first data qubit 230 is not included in any other Z-type stabilizers, an X-error in the first data qubit 230 will only trigger a detection event in the second detector 224 and no other detectors in the matching graph. As such, the second non-decomposable edge 234 connects the second detector 224 to another boundary of the surface code 200. An edge data structure for the second non-decomposable edge 234 has an entry for an X-error in the first data qubit 230. The prior probability for an X-error in the first data qubit 230 may be included in the edge data structure for the second non-decomposable edge 234. Note that other qubit errors may also trigger a detection event only in the second detector 224 (and no other detectors). These other qubit errors may have entries in the edge data structure for the second non-decomposable edge 234. The weight of the second non-decomposable edge 234 may be based on the sum of the probabilities for all errors associated with the second non-decomposable edge 234.

Because the first data qubit 230 is included in both the first stabilizer 202 and the second stabilizer 204, a Y-error in the first data qubit 230 (occurring prior to the time-slice of FIG. 2A) may generate detection events at both the first detector 222 and the second detector 224. Because the first data qubit 230 is not included in any other X-type or Z-type stabilizers, a Y-error in the first data qubit 230 will only trigger detection events in the first detector 222 and the second detector 224 and no other detectors in the matching graph. As such, the first decomposable potential-edge 236 connects the first detector 222 and the second detector 204. An edge data structure for the first decomposable potential-edge 236 has an entry for a Y-error in the first data qubit 230. The prior probability for a Y-error in the first data qubit 230 may be included in the edge data structure for the first decomposable potential-edge 236. Note that other qubit errors may also trigger detection events in both the first detector 222 and the second detector 224. These other qubit errors may have entries in the edge data structure for the first-decomposable potential-edge 236. The weight of the first decomposable potential-edge 236 may be based on the sum of the probabilities for all errors associated with the first decomposable-potential-edge 236.

To generate the matching graph, every possible error for each qubit may be considered for each time-slice and the edges are added to the matching graph as discussed above. In the non-limiting example of FIG. 2A, each of the three possible error types for the first data qubit 230 and the second data qubit 240 have been analyzed and the corresponding edges have been added to the matching graph. For instance, a Z-error on the second data qubit 240 would generate a detection event only in the third detector 226. Thus, the third non-decomposable edge 242 connects the third detector 226 to another boundary of the surface code 200. An X-error on the second data qubit 240 would generate a detection event only in the fourth detector 228. Thus, the fourth non-decomposable edge 244 connects the fourth detector 228 to another boundary of the surface code 200.

As noted above, a decomposable error may be decomposed into two or more non-decomposable errors. In this non-limiting example, a Y-error occurring on a particular qubit may be decomposed into an X-error and a Z-error both occurring on the particular qubit. As discussed above, an X-error on the first data qubit 230 is associated with the second non-decomposable edge 234, a Z-error on the first data qubit 230 is associated with the first non-decomposable edge 232, and a Y-error on the first data qubit 230 is associated with the first decomposable potential-edge 236. Accordingly, the first decomposable potential-edge 236 may be decomposed into the first non-decomposable edge 232 and the second non-decomposable edge 234. For similar reasons, the second decomposable potential-edge 246 may be decomposed into the third non-decomposable edge 242 and the fourth non-decomposable edge 244. As described below, in some embodiments, the first decomposable potential-edge 236 and the second decomposable potential-edge 246 may not be included in an updated MG because these decomposable potential-edges may not pass a local-connectivity test and these decomposable potential-edges are already represented in the MG by the non-decomposable edges.

As another example of decomposing a decomposable edge into two or more non-decomposable edges, FIG. 2B shows the surface code 200 of FIG. 2A and another portion of the matching graph for the surface code 200, according to various embodiments. In FIG. 2B, surface code 200 is shown with the first stabilizer 202, the second stabilizer 204, the third stabilizer 206, and the fourth stabilizer 208 of FIG. 2A, with additional stabilizers being indicated: a fifth stabilizer 252 and a sixth stabilizer 254. The fifth stabilizer 252 is of the second stabilizer type (e.g., an X-type stabilizer) and the sixth stabilizer is of the first stabilizer type (e.g., a Z-type stabilizer). The fifth stabilizer 252 is associated with a fifth detector 272 (e.g., of the second detector type) and the sixth stabilizer 254 is associated with a sixth detector 274 (e.g., of the first detector type). In addition to showing the first data qubit 230 and the second data qubit 240 of FIG. 2A, FIG. 2B shows markings for a third data qubit 250. The third data qubit is included in each of the second stabilizer 204, the third stabilizer 206, the fifth stabilizer 252 and the sixth stabilizer 254. For purposes of clarity, the first non-decomposable edge 232, the second non-decomposable edge 234, the third non-decomposable edge 242, the fourth non-decomposable edge 244, the first decomposable potential-edge 236, and the second decomposable potential-edge 246 are not shown in FIG. 2B.

When generating a MG for the surface code 200, each error type (both non-decomposable error types and decomposable error types) for each data qubit may be considered. Such an analysis for the first data qubit 230 and the second data qubit 240 may be performed in conjunction with FIG. 2A, resulting in the generation of he first non-decomposable edge 232, the second non-decomposable edge 234, the third non-decomposable edge 242, the fourth non-decomposable edge 244, the first decomposable potential-edge 236, and the second decomposable potential-edge 246.

When performing a similar analysis for the third data qubit 250, the embodiments may begin by initially considering the set of non-decomposable errors. A qubit error of the first non-decomposable type would trigger a first detection event in the fifth detector 272 of the fifth stabilizer 252 and a second detection event in the third detector 226 of the third stabilizer 206. Thus, a fifth non-decomposable edge 282 (of the first non-decomposable edge type) may be generated connecting the fifth detector 272 (of the fifth stabilizer 252) to the third detector (of the third stabilizer 206).

A qubit error of the second non-decomposable type would trigger a third detection event in the sixth detector 274 of the sixth stabilizer 254 and a fourth detection event in the second detector 224 of the second stabilizer 204. Thus, a sixth non-decomposable edge 284 (of the second non-decomposable edge type) may be generated connecting the sixth detector 274 (of the sixth stabilizer 254) to the second detector 224 (of the second stabilizer 204).

After considering each non-decomposable error type for each qubit, each decomposable error type may be considered for each qubit. A qubit error of the first decomposable type would trigger four separate detection events, one in each of the second detector 224 (of the second stabilizer 204), the third detector 226 (of the third stabilizer 206), the fifth detector 272 (of the first stabilizer 252), and the sixth detector 274 (of the sixth stabilizer 254). Thus, a third decomposable potential-edge 286 (of the first decomposable edge type) may be generated connecting each of the second detector 224 (of the second stabilizer 204), the third detector 226 (of the third stabilizer 206), the fifth detector 272 (of the first stabilizer 252), and the sixth detector 274 (of the sixth stabilizer 254). Note that the third decomposable potential-edge 286 is a potential-hyperedge connecting more than two detectors.

The third decomposable potential-edge 286 may be decomposed into the fifth non-decomposable edge 282 (of the first non-decomposable edge type) and the sixth non-decomposable edge 284 (of the second non-decomposable edge type). In this non-limiting example, the first non-decomposable error type (and thus the first non-decomposable edge type) include Z-type errors. The second non-decomposable error type (and thus the second non-decomposable edge type) may include X-type errors. The first decomposable error type (and thus the first decomposable edge type) may include Y-type errors.

As discussed in conjunction with FIGS. 2A-2B, the embodiments subdivide qubit error types into a set of non-decomposable error types and a set of decomposable error types. A decomposable error type may be decomposed into two or more non-decomposable error types. After subdividing the error types into non-decomposable error types and decomposable error types, a two stage process is performed when generating the MGs of the embodiments. In the first stage, an initial MG is generated. The initial MG includes a set of nodes and a set of non-decomposable edges. The set of nodes of the initial MG include the detectors of the QEC code, as well as the boundaries of the QEC code. That is, each node of the set of nodes corresponds to either a detector of the set of detectors or a boundary of the QEC code. For surface code 200 of FIG. 2A-2B, the set of non-decomposable edges includes the first non-decomposable edge 232, the second non-decomposable edge 234, the third non-decomposable edge 242, and the fourth non-decomposable edge 244 of FIG. 2A, as well as the fifth non-decomposable edge 282 and the sixth non-decomposable edge 284 of FIG. 2B. Note that additional edges are included in the set of non-decomposable edges.

In the second stage, an updated MG is generated that includes the set of nodes, the set of non-decomposable edges, and a set of decomposable edges. The set of decomposable edges is generated by filtering a set of decomposable potential-edges. For surface code 200, the set of decomposable potential-edges includes the first decomposable potential-edge 236 and the second decomposable potential-edge 246 of FIG. 2A, as well as the third decomposable potential-edge 286 of FIG. 2B. Note that additional potential-edges (not shown in FIGS. 2A-2B) are included in the set of decomposable potential-edges. The filtering of the set of decomposable potential-edges is based on a local-connectivity test of each decomposable potential-edge, as applied on the MG. Thus, the set of decomposable edges is a subset of the set of decomposable potential-edges.

A conventional MG may include the entire set of decomposable potential-edges, whereas in the present embodiments, the set of decomposable edges (e.g., included in the updated MG of the embodiments) may be a much smaller subset of edges than the set of decomposable potential-edges (e.g., included in conventional MGs). Some decomposable potential-edges generate complexity and entanglement in a conventional MG. In the embodiments, only decomposable potential-edges that do not unnecessarily increase the complexity/entanglement of the graph pass the filtering process and are included in the updated MG. The local-connectivity test provides a measure of whether any particular decomposable potential-edge will generate complexity and entanglement in the updated MG. Decomposable potential-edges that are not included in the updated MG are somewhat redundant in that a decomposable edge may be decomposed into two or more non-decomposable edges that are already included in the updated MG. That is, these vetoed decomposable potential-edges lead to less efficiency and poorer performance when the MG is employed to decode qubit errors.

FIG. 2C shows the surface code 200 of FIGS. 2A-2B and an initial matching graph for the surface code 200, according to various embodiments. In the first stage of the embodiments, the initial MG 290 is generated by considering every potential qubit error of the non-decomposable error types. Thus, the edges of the initial MG 290 are non-decomposable edges that are associated with non-decomposable errors only. The initial MG 290 may include a set of disconnected subgraphs. In the non-limiting example of surface code 200, the set of disconnected subgraphs includes a first subgraph 292 and a second subgraph 294. Each subgraph of the initial MG may be associated with a separate non-decomposable error type. In this non-limiting example, the first subgraph 292 is associated with a first non-decomposable error type and the second subgraph 294 is associated with a second non-decomposable error type. The nodes (e.g., each node of an MG corresponding to a detector of the QEC code or boundary of the QEC code) of each subgraph are not connected (via non-decomposable edges) to the nodes of the other subgraphs via the set of non-decomposable edges. In this sense, the subgraphs of the initial MG are disconnected or “unentangled” from one another.

Note that the inclusion of any of the first decomposable potential-edge 236 of FIG. 2A, the second decomposable potential-edge 246 of FIG. 2A, or the third decomposable potential-edge 286 of FIG. 2B would “entangle” the first subgraph 292 and the second subgraph 294 of FIG. 2C. As is shown below, these decomposable potential-edges do not pass the local-connectivity test, and thus these decomposable potential-edges are not included in the updated MG for surface code 200. Rather, the corresponding non-decomposable edges are correlated and reweighted to account for the decomposable error that does not have an explicit decomposable edge included in the updated MG.

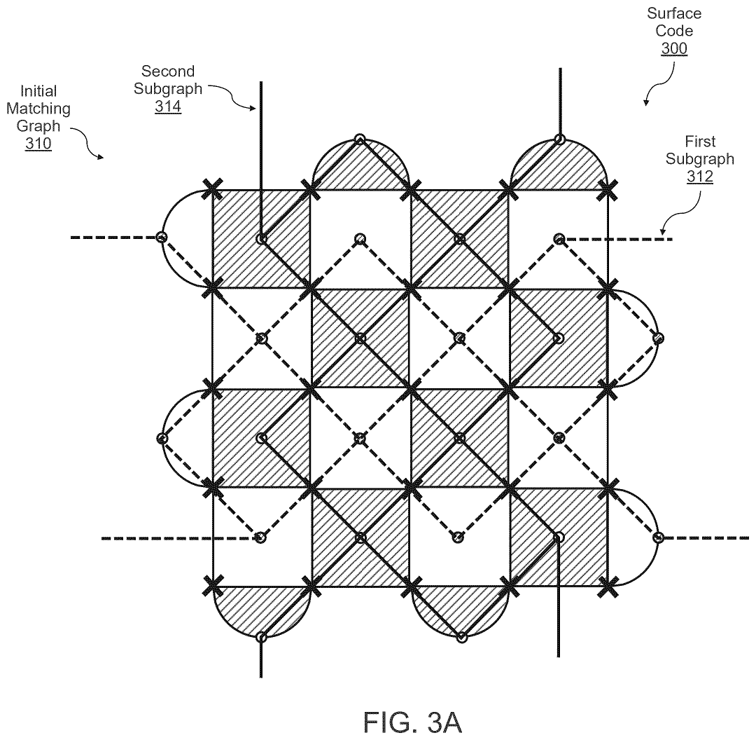

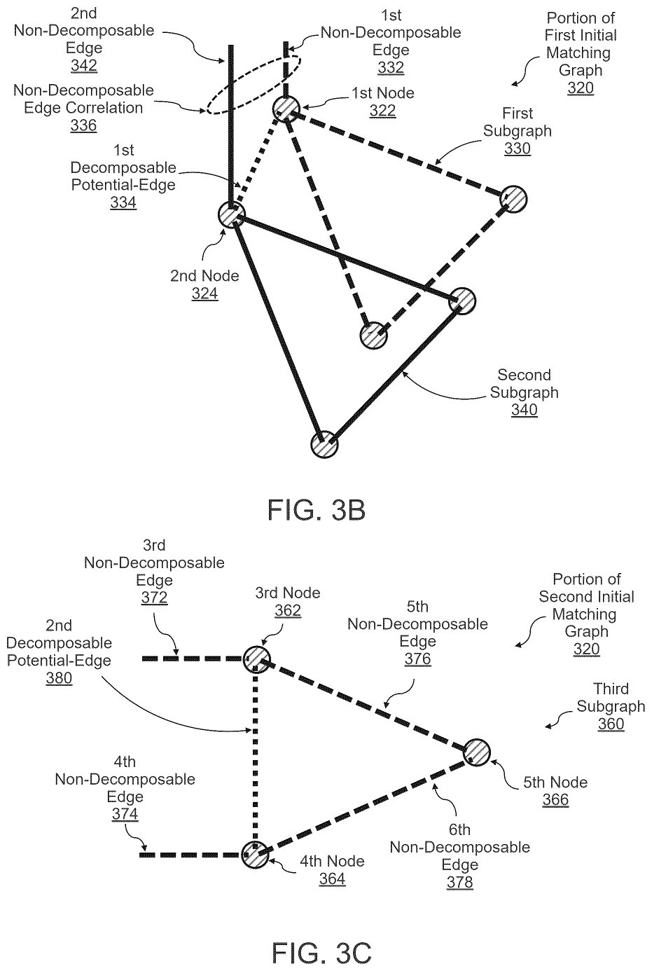

FIG. 3A shows another surface code 300 and an initial matching graph 310 for the surface code 300, according to various embodiments. In contrast to surface code 200 of FIGS. 2A-2C, surface code 300 of FIG. 3A is a distance d=5 surface code. However, the generation of the initial MG 310 is similar to the generation of the initial MG 290 for surface code 200, as shown in FIG. 2C. That is, the initial MG 310 is generated by considering every potential qubit error of the non-decomposable error types. Thus, the edges of the initial MG 310 are non-decomposable edges that are associated with non-decomposable errors only. The initial MG 310 may include a set of disconnected subgraphs. In the non-limiting example of surface code 300, the set of disconnected subgraphs includes a first subgraph 312 and a second subgraph 314. Each subgraph of the initial MG may be associated with a separate non-decomposable error type. In this non-limiting example, the first subgraph 312 is associated with a first non-decomposable error type and the second subgraph 314 is associated with a second non-decomposable error type. The nodes (e.g., each node of an MG corresponding to a detector of the QEC code or boundary of the QEC code) of each subgraph are not connected (via non-decomposable edges) to the nodes of the other subgraphs via the set of non-decomposable edges. In this sense, the subgraphs of the initial MG are disconnected or “unentangled” from one another.

The initial MG 290 of FIG. 2C and the initial MG 310 of FIG. 3A are generated in the first stage of the embodiments by considering each possible qubit error that is of a non-decomposable error type. In the second stage of the embodiments, the decomposable error types are considered to generate the updated MG. In this second stage, the set of decomposable potential-edges is generated by considering each possible decomposable qubit error. After generating the set of decomposable potential-edges, individual decomposable potential-edges of the set of decomposable potential-edges may be selectively added to the initial MG (e.g., initial MG 290 and/or initial MG 310) when the decomposable potential-edge does not unnecessarily increase the entanglement (or connectivity) between the subgraphs (e.g., the first subgraph 292/312 and the second subgraph 294/314 of the initial MG 290/310). That is, the set of decomposable potential-edges is filtered (e.g., via the local-connectivity test) to generate a set of decomposable edges that are included in the updated MG. When a decomposable potential-edge is added to the updated MG, the decomposable potential-edge becomes a decomposable edge of the updated MG. As shown above, a decomposable edge may be decomposed into two or more non-decomposable edges. The two or more non-decomposable edges representing a decomposable error (or decomposable edge) may already be included in the initial MG. As such, as long as the two or more non-decomposable edges are correlated (and reweighted) to account for the decomposable error, explicitly including a decomposable potential-edge for the decomposable error in the updated MG may be unnecessary to decode the decomposable error. Thus, many decomposable potential-edges that would otherwise be included in a conventional MG are absent from the MGs of the embodiments.

A decomposable potential-edge is added to the updated MG only when the decomposable potential-edge passes a local-connectivity test. When a decomposable potential-edge passes the local-connectivity test and is added to the updated MG, the decomposable potential-edge becomes a decomposable edge of the updated MG. When the decomposable potential-edge does not pass the local-connectivity test, the decomposable potential-edge is not included in the updated MG. Rather, the two or more non-decomposable edges that the decomposable potential-edge may be decomposed into are correlated via the decomposable error that leads to the decomposable potential-edge. The correlation between the two or more non-decomposable edges may be encoded in a data structure for the MG. The data structure may additionally encode a total weight for each non-decomposable edge and each decomposable edge, as well as a list of possible candidate qubit errors associated with the edge. The weight of a particular edge may be a sum of the probability (or error rate) of each possible candidate qubit error associated with the edge. After correlating the two or more non-decomposable edges, each of the two or more non-decomposable edges may then be reweighted to account for the inclusion of decomposable error. During decoding, this correlation between the non-decomposable edges as well as the reweighting of the non-decomposable edges may be employed to infer an occurrence of a qubit error of the decomposable error type in the absence of an explicit graph edge representing the error mechanism in the MG.

As discussed above, to generate the updated MG, each possible decomposable error is considered. A decomposable edge (for a particular qubit error) is added to the initial MG only if the decomposable edge connects nodes that have already been locally-connected via the non-decomposable edges (e.g., the local-connectivity test). If the decomposable edge does not connect nodes that are already locally-connected, then the decomposable edge is not explicitly included in the updated MG. Rather, in such cases, the decomposable edge is only “implicitly” included in the updated MG by correlating and reweighting the corresponding non-decomposable edges. Correlating two or more non-decomposable edges may include listing the decomposable errors in the data structure that lists the qubit errors associated with the non-decomposable edges. Thus, after the generation of the updated MG, and some of the non-decomposable edges are correlated to account for decomposable errors with decomposable potential-edges that do not pass the local-connectivity test, these non-decomposable (and correlated) edges may be associated with non-decomposable errors, as well as decomposable errors. To generate both the initial MG and the updated MG, a detector error model (DEM) for the set of qubits may be consulted.

FIGS. 3B-3C show applications of the local-connectivity test to various decomposable potential-edges. FIG. 3B shows a portion of a first initial MG 320 and a first decomposable potential-edge 334 that does not pass the local-connectivity test, according to various embodiments. The portion of the first initial MG 320 includes a set of nodes (e.g., the first node 322 and the second node 324), a first subgraph 330, and a second subgraph 340 that is disconnected from the first subgraph 330. The first subgraph 330 includes non-decomposable edges of a first non-decomposable edge-type, e.g., first non-decomposable edge 332 connected to first node 322. The non-decomposable edges of the first non-decomposable edge type of the first subgraph 330 are associated with a first non-decomposable error type. The second subgraph 340 includes non-decomposable edges of a second non-decomposable edge-type, e.g., second non-decomposable edge 342 connected to the second node 324. The non-decomposable edges of the second non-decomposable edge type of the second subgraph 340 are associated with a non-decomposable error type.

During the second stage of generating an MG, each decomposable potential/possible qubit error is considered to generate a set of decomposable potential-edges. The set of decomposable potential-edges may include a first decomposable potential-edge 334 that spans or connects the first node 322 and the second node 324. The decomposable potential-edges are associated with one or more decomposable error types. The first decomposable potential-edge 334 does not pass the local-connectivity test because the first node 322 and the second node 324 are not locally connected, e.g., the first node 322 is included only in the first subgraph 330 and the second node 324 is included only in the second subgraph 340, which is disconnected from the first subgraph 330. That is, the second node 324 cannot be reached from the first node 322 via one or more “hops” along the edges already included in the initial MG 320.

The decomposable error type associated with the first decomposable potential-edge 334 can be decomposed into a first non-decomposable error type (e.g., associated with the first non-decomposable edge 332) and a second non-decomposable error type (e.g., associated with the second non-decomposable edge 342). Thus, the first decomposable potential-edge 334 may be decomposed into the first non-decomposable edge 332 and the second non-decomposable edge 342. Because the first decomposable potential-edge 334 did not pass the local-connectivity test, rather than explicitly including the first decomposable potential-edge 334 in the updated MG, the first non-decomposable edge 332 and the second non-decomposable edge 342 are correlated (e.g., as shown via the non-decomposable edge correlation 336) and reweighted to account for the one or more decomposable qubit errors associated with the first non-decomposable edge 332.

In contrast to FIG. 3B, FIG. 3C shows a portion of a second initial MG 350 and a second decomposable potential-edge 380 that does pass the local-connectivity test, according to various embodiments. The portion of the second initial MG 350 includes a set of nodes (e.g., the third node 372, the fourth node 364, and the fifth node 326) and a third subgraph 360 (e.g., one or more other subgraphs disconnected from the third subgraph 360 may be included in the portion of the second initial MG 350). The third subgraph 360 includes non-decomposable edges of a first non-decomposable edge-type, e.g., a third non-decomposable edge 372 connected to the third node 362, a fourth non-decomposable edge 374 connected to the fourth node 352, a fifth non-decomposable edge 376 connecting the third node 362 to the fifth node 366, and a sixth non-decomposable edge 378 connecting the fourth node 364 to the fifth node 366. The non-decomposable edges of the first non-decomposable edge type of the first subgraph 360 are associated with a first non-decomposable error type.

As noted above, during the second stage of generating an MG, each decomposable potential/possible qubit error is considered to generate a set of decomposable potential-edges. The set of decomposable potential-edges may include a second decomposable edge 380 that spans or connects the third node 362 and the fourth node 364. The decomposable potential-edges are associated with one or more decomposable error types. The second decomposable potential-edge 380 does pass the local-connectivity test because it is already possible to traverse from the third node 362 to the fourth node 364 by “hopping” the fifth non-decomposable edge 376 and the sixth non-decomposable edge 378. Thus, the second decomposable potential-edge 380 is included in the updated MG.

### Example Methods for Generating a Matching Graph and Decoding Qubit Errors

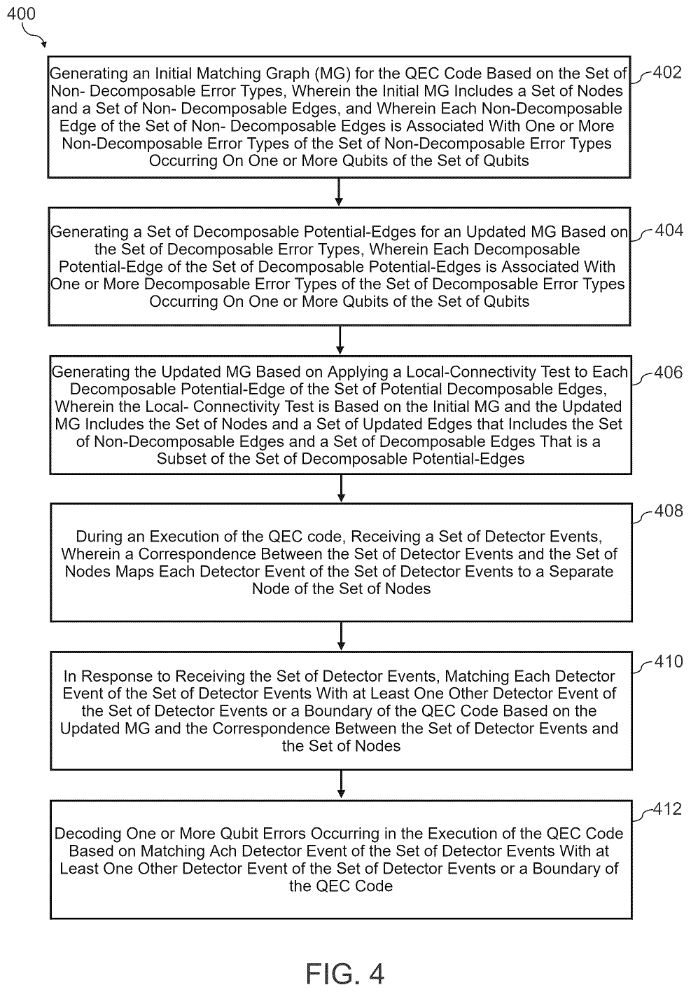

FIG. 4 depicts a flow chart diagram of an example method 400 for decoding qubit errors on a set of qubits of a quantum computing system (QCS). The QCS implements a quantum error correction (QEC) code. The QEC code may be a surface code or a color code. Although the embodiments are not so limited, and other QEC codes (e.g., a repetition code) may be employed. The set of qubits is subject to a set of error types. The set of error types includes a set of non-decomposable error types and a set of decomposable error types. Each decomposable error type of the set of decomposable error types is decomposable into two or more non-decomposable error types of the set of non-decomposable error types based on a decomposable property of an error operator for each error type of the set of error types.

The first non-decomposable error type may be associated with a first error operator. The second non-decomposable error may be associated with a second error operation. The first decomposable error type may be associated with a third error operator. The third error operator may be composed of a product of the first error operator and the second error operator. That is, the third error operator may be decomposed into the first error operator and the second error operator. Each of the first error operator, the second error operator, and the third error operator is a unitary Hermitian operator.

For instance, each error type of the set of error types may correspond to a separate Pauli-error type of a set of Pauli-error types. A first non-decomposable error type of the set of non-decomposable error types is a first Pauli-error type of the set of Pauli-error types. A second non-decomposable error type is a second Pauli-error type of the set of Pauli-error types. A first decomposable error type of the set of decomposable error types is a third Pauli-error type of the set of Pauli error types. The first Pauli-error type may have a first error operator (e.g., a first Pauli matrix), the second Pauli-error type may have a second error operator (e.g., a second Pauli matrix), and the third Pauli-error type may have a third error operator (e.g., a third Pauli matrix). Any Pauli matrix may be composed of a product of the other two Pauli matrices. Thus, each Pauli-error type is decomposable into the other two Pauli-error types (e.g., the decomposable property of the error operator).

Method 400 begins at block 402, where an initial matching graph (MG) for the QEC code is generated. Generating the initial MG is based on the set of non-decomposable error types. The initial MG includes a set of nodes and a set of non-decomposable edges. Each non-decomposable edge of the set of non-decomposable edges is associated with one or more non-decomposable error types of the set of non-decomposable error types occurring on one or more qubits of the set of qubits.

Generating the initial MG may include generating a set of detectors based on a set of time-slices of the QEC code. The set of nodes may be generated based on the set of detectors and a set of boundaries of the QEC code. Each node of the set of nodes corresponds to a separate detector of the set of detectors or a separate boundary of the set of boundaries of the QEC code. Each detector of the set of detectors corresponds to a set of qubit measurements occurring during an execution of the QEC code.

Generating the initial MG may include generating the set of non-decomposable edges. Generating the set of non-decomposable edges may be based on the QEC code, the set of nodes, the set of non-decomposable error types, and a detector error model (DEM).

The initial MG may be a weighted graph. The initial MG includes a set of initial weights. Each initial weight of the set of initial weights corresponds to a separate edge in the set of non-decomposable edges.

Generating the initial MG may include generating the initial set of weights. Generating the initial weight for a corresponding non-decomposable edge may be based on a sum of a prior probability for each of the one or more non-decomposable error types of the set of non-decomposable error types occurring on one or more qubits of the set of qubits that is associated with the corresponding non-decomposable edge. The prior probability for the non-decomposable error type occurring on the qubit may be encoded in a detector error model (DEM).

At block 404, a set of decomposable potential-edges is generated for an updated MG. Each decomposable potential-edge in the set of decomposable potential-edges is a decomposable edge that may potentially be included in the updated MG. The generation of the set of decomposable errors is based on the set of decomposable error types. Each decomposable potential-edge of the set of decomposable potential-edges is associated with one or more decomposable error types of the set of decomposable error types occurring on one or more qubits of the set of qubits. Generating the set of decomposable potential-edges may be based on the QEC code, the set of nodes, the set of decomposable error types, and the DEM.

Generating the set of decomposable potential-edges may include generating a set of potential weights. Each potential weight of the set of potential weights corresponds to a separate decomposable potential-edge of the set of decomposable potential-edges. Generating a potential weight for a corresponding decomposable potential-edge is based on a sum of a prior probability for each of a one or more decomposable error types of the set of decomposable error types occurring on one or more qubits of the set of qubits that is associated with the corresponding decomposable potential-edge.

At block 406, the updated MG is generated. Generating the updated MG is based on applying a local-connectivity test to each decomposable potential-edge of the set of decomposable potential-edges. The local-connectivity test is based on the initial MG. The updated MG includes the set of nodes and a set of updated edges. The set of updated edges includes the set of non-decomposable edges and a set of decomposable edges. The set of decomposable edges is a subset of the set of decomposable potential-edges.

Generating the updated MG includes generating the set of decomposable edges. Each edge of the set of updated edges is associated with a separate subset of the set of nodes. The edge connects each node in the associated subset of nodes to every other node in the associated subset of nodes. The updated MG may be a weighted graph that includes a set of updated weights. Each updated weight of the set of updated weights corresponds to a separate updated edge of the set of updated edges.

Generating the set of decomposable edges may be performed by filtering the set of decomposable potential-edges. Filtering the set of decomposable edges is based on applying the local-connectivity test to each decomposable potential-edge of the set of decomposable potential-edges.

Generating the updated MG may include generating the set of updated weights. Each updated weight of the set of updated weights corresponds to a separate updated edge of the set of updated edges and is based on a combination of the set of initial weights, the set of potential weights, and which decomposable potential-edges of the set of decomposable potential-edges passed the filter of the set of decomposable potential-edges to be included in the set of decomposable edges.

More particularly, filtering the set of decomposable potential-edges includes, when a decomposable potential-edge of the set of decomposable potential-edges passes the local-connectivity test, the decomposable potential-edge is included as a decomposable edge in the set of decomposable edges. The decomposable potential-edge passes the local-connectivity test when the decomposable potential-edge connects a subset of the set of nodes that are locally connected in the initial MG via the set of non-decomposable edges. This is a condition for the decomposable potential-edge passing the filtering process.

When the decomposable potential-edge fails to pass the local-connectivity test, the decomposable potential-edge is excluded as a decomposable edge in the set of decomposable edges. The decomposable potential-edge fails to pass the local-connectivity test when the subset of nodes connected by the decomposable potential-edge is not locally connected in the MG via the set of non-decomposable edges. This is a condition for the decomposable potential-edge not passing the filtering process.

In some embodiments, each updated edge of the set of updated edges has an edge data structure. An edge data structure for an updated edge encodes an indication of a set of potential qubit errors associated with a subset of the set of nodes that are connected via the updated edge. The indication of a potential qubit error in the set of potential qubit errors includes a unique qubit identifier (ID) of an affected qubit of the set of qubits that is affected by the potential qubit error. The indication of a potential error also includes an error type of the set of error types for the potential qubit error. The indication of the potential error further includes a prior probability of the affected qubit being subject to the error type. The edge data structure for the updated edge further encodes the updated weight of the set of updated weights that corresponds to the updated edge. The updated weight is based on the prior probability of each potential qubit error in the set of potential qubit errors.

In at least one embodiment, a first decomposable potential-edge of the set of decomposable potential-edges is decomposable into a first non-decomposable edge of the set of non-decomposable edges and a second non-decomposable edge of the set of non-decomposable edges. In such scenarios, the first decomposable potential-edge is associated with a first decomposable error type, the first non-decomposable edge is associated with a first non-decomposable error type, and the second non-decomposable edge is associated with a second non-decomposable error type. The first decomposable error type may be decomposed into the first non-decomposable error type and the second non-decomposable error type.

When the first decomposable potential-edge does not pass the local-connectivity test, the first decomposable potential-edge is not included in the set of decomposable edges for the updated MG. Rather, the first non-decomposable edge and the second non-decomposable edge are correlated and their respective weights are reweighted.

In some embodiments, a first edge data structure for the first non-decomposable edge further encodes the correlation between the first non-decomposable edge and the second non-decomposable edge. The correlation between the first non-decomposable edge and the second non-decomposable edge indicates that the first decomposable potential-edge is decomposable into the first non-decomposable edge and the second non-decomposable edge. The correlation also encodes that the first decomposable potential-edge failed to pass the local-connectivity test. A second edge data structure for the second non-decomposable edge has similar encodings for the second non-decomposable edge.

A first updated weight of the set of updated weights corresponds to the first non-decomposable edge. A first initial weight of the set of initial weights corresponds to the first non-decomposable edge. A second updated weight of the set of updated weights corresponds to the second non-decomposable edge. A second initial weight of the set of initial weights corresponds to the second non-decomposable edge. The first updated weight represents an updating of the first initial weight based on the correlation between the first non-decomposable edge and the second non-decomposable edge. The second updated weight represents an updating of the second initial weight based on the correlation between the first non-decomposable edge and the second non-decomposable edge.

At block 408, and during an execution of the QEC code, a set of detector events is received. A correspondence between the set of detector events and the set of nodes maps each detector event of the set of detector events to a separate node of the set of nodes. The updated MG may be generated prior to receiving the set of detector events.

At block 410, and in response to receiving the set of detector events, each detector event of the set of detector events is matched with at least one other detector event of the set of detector events or a boundary of the QEC code. Matching the detector events to other detector events or a boundary of the QEC code is based on the updated MG and the correspondence between the set of detector events and the set of nodes.

Matching each detector event of the set of detector events with at least one other detector event of the set of detector events or a boundary of the QEC code may be based on a minimum weight perfect matching (MWPM) algorithm and the updated MG.

At block 412, one or more qubit errors are decoded. The one or more qubit errors occurred during the execution of the QEC code. Decoding the one or more qubit errors is based on matching each detector event of the set of detector events with at least one other detector event of the set of detector events or a boundary of the QEC code.

### Additional Embodiments

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for decoding qubit errors on a set of qubits of a quantum computing system (QCS) that implements a quantum error correction (QEC) code, wherein the set of qubits is subject to a set of error types that includes a set of non-decomposable error types and a set of decomposable error types, the method comprising:
generating an initial matching graph (MG) for the QEC code based on the set of non-decomposable error types, wherein the initial MG includes a set of nodes and a set of non-decomposable edges, and wherein each non-decomposable edge of the set of non-decomposable edges is associated with one or more non-decomposable error types of the set of non-decomposable error types occurring on one or more qubits of the set of qubits;
generating a set of decomposable potential-edges for an updated MG based on the set of decomposable error types, wherein each decomposable potential-edge of the set of decomposable potential-edges is associated with one or more decomposable error types of the set of decomposable error types occurring on one or more qubits of the set of qubits; and;
generating the updated MG based on the set of decomposable potential-edges, wherein the updated MG includes the set of nodes and a set of updated edges that includes the set of non-decomposable edges and a set of decomposable edges.

2. The method of claim 1, wherein each edge of the set of updated edges is associated with a separate subset of the set of nodes such that the edge connects each node in the associated subset of nodes to every other node in the associated subset of nodes.

3. The method of claim 1, wherein each node of the set of nodes corresponds to either a boundary of the QEC code or a detector of a set of detectors of the QEC code and each detector of the set of detectors corresponds to a set of qubit measurements occurring during an execution of the QEC code.

4. The method of claim 1, wherein generating the updated MG is further based on applying a local-connectivity test to each decomposable potential-edge of the set of decomposable potential-edges, and the set of decomposable edges is a subset of the set of decomposable potential-edges

5. The method of claim 4, wherein when a decomposable potential-edge of the set of decomposable potential-edges passes the local-connectivity test, the decomposable potential-edge is included as a decomposable edge in the set of decomposable edges and when the decomposable potential-edge fails to pass the local-connectivity test, the decomposable potential-edge is excluded as a decomposable edge in the set of decomposable edges.

6. The method of claim 5, wherein the decomposable potential-edge passes the local-connectivity test when the decomposable potential-edge connects a subset of the set of nodes that are locally connected in the initial MG via the set of non-decomposable edges and the decomposable potential-edge fails to pass the local-connectivity test when the subset of nodes connected by the decomposable potential-edge is not locally connected in the MG via the set of non-decomposable edges.

7. The method of claim 1, wherein the initial MG and the updated MG are weighted graphs, the initial MG including a set of initial weights, each initial weight of the set of initial weights corresponds to a separate edge in the set of non-decomposable edges, the updated MG including a set of updated weights, and each updated weight of the set of updated weights corresponds to a separate updated edge of the set of updated edges.

8. The method of claim 7, wherein each updated edge of the set of updated edges has an edge data structure that encodes an indication of a set of potential qubit errors associated with a subset of the set of nodes that are connected via the updated edge, an indication of a potential qubit error in the set of potential qubit errors includes a unique qubit identifier (ID) of an affected qubit of the set of qubits that is affected by the potential qubit error, an error type of the set of error types for the potential qubit error, a prior probability of the affected qubit being subject to the error type, and the updated weight of the set of updated weights that corresponds to the updated edge, and wherein the updated weight is based on the prior probability of each potential qubit error in the set of potential qubit errors.

9. The method of claim 8, wherein a first edge data structure for a first non-decomposable edge of the set of updated edges further encodes a correlation between the first non-decomposable edge and a second non-decomposable edge of the set of updated edges, the correlation between the first non-decomposable edge and the second non-decomposable edge indicating that a first decomposable potential-edge of the set of decomposable potential-edge is decomposable into the first non-decomposable edge and the second non-decomposable edge, and that the first decomposable potential-edge failed to pass a local-connectivity test.

10. The method of claim 9, wherein a first updated weight of the set of updated weights corresponds to the first non-decomposable edge, a first initial weight of the set of initial weights corresponds to the first non-decomposable edge, a second updated weight of the set of updated weights corresponds to the second non-decomposable edge, a second initial weight of the set of initial weights corresponds to the second non-decomposable edge, the first updated weight represents an updating of the first initial weight based on the correlation between the first non-decomposable edge and the second non-decomposable edge, and the second updated weight represents an updating of the second initial weight based on the correlation between the first non-decomposable edge and the second non-decomposable edge.

11. The method of claim 1, further comprising:
generating a set of detectors based on a set of time-slices of the QEC code;
generating the set of nodes based on the set of detectors and a set of boundaries of the QEC code, wherein each node of the set of nodes corresponds to a separate detector of the set of detectors or a separate boundary of the set of boundaries of the QEC code;
generating the set of non-decomposable edges based on the QEC code, the set of nodes, the set of non-decomposable error types, and a detector error model (DEM);
generating the set of decomposable potential-edges based on the QEC code, the set of nodes, the set of decomposable error types, and the DEM; and
generating the set of decomposable edges by filtering the set of decomposable potential-edges based on applying a local-connectivity test to each decomposable potential-edge of the set of decomposable potential-edges.

12. The method of claim 11, further comprising:
generating a set of initial weights, wherein each initial weight of the set of initial weights corresponds to a separate non-decomposable edge of the set of non-decomposable edges and is based on a sum of a prior probability for each of the one or more non-decomposable error types of the set of non-decomposable error types occurring on one or more qubits of the set of qubits that is associated with the corresponding non-decomposable edge, and wherein the prior probability for the non-decomposable error type occurring on the qubit is encoded in the DEM;
generating a set of potential weights, wherein each potential weight of the set of potential weights corresponds to a separate decomposable potential-edge of the set of decomposable potential-edges and is based on a sum of a prior probability for each of a one or more decomposable error types of the set of decomposable error types occurring on one or more qubits of the set of qubits that is associated with the corresponding decomposable potential-edge; and
generating a set of updated weights, wherein each updated weight of the set of updated weights corresponds to a separate updated edge of the set of updated edges and is based on a combination of the set of initial weights, the set of potential weights, and which decomposable potential-edges of the set of decomposable potential-edges passed the filter of the set of decomposable potential-edges to be included in the set of decomposable edges.

13. The method of claim 1, wherein each decomposable error type of the set of decomposable error types is decomposable into two or more non-decomposable error types of the set of non-decomposable error types based on a decomposable property of an error operator for each error type of the set of error types.

14. The method of claim 1, wherein the initial MG includes a set of disconnected subgraphs, each disconnected subgraph of the set of disconnected subgraphs is disconnected from each other disconnected subgraph of the set of disconnected subgraphs and corresponds to a separate non-decomposable error type of the set of non-decomposable error types, and each non-decomposable edge in each disconnected subgraph is associated with the non-decomposable error type corresponding to the disconnected graph.

15. The method of claim 1, wherein each error type of the set of error types corresponds to a separate Pauli-error type of a set of Pauli-error types, a first non-decomposable error type of the set of non-decomposable error types is a first Pauli-error type of the set of Pauli-error types, a second non-decomposable error type is a second Pauli-error type of the set of Pauli-error types, and a first decomposable error type of the set of decomposable error types is a third Pauli-error type of the set of Pauli error types.

16. The method of claim 1, further comprising:
during an execution of the QEC code, receiving a set of detector events, wherein a correspondence between the set of detector events and the set of nodes maps each detector event of the set of detector events to a separate node of the set of nodes; and
in response to receiving the set of detector events, matching each detector event of the set of detector events with at least one other detector event of the set of detector events or a boundary of the QEC code based on the updated MG and the correspondence between the set of detector events and the set of nodes; and
decoding one or more qubit errors occurring in the execution of the QEC code based on matching each detector event of the set of detector events with at least one other detector event of the set of detector events or a boundary of the QEC code.

17. The method of claim 16, wherein matching each detector event of the set of detector events with at least one other detector event of the set of detector events or a boundary of the QEC code is based on a minimum weight perfect matching (MWPM) algorithm and the updated MG.

18. The method of claim 16, wherein the updated MG is generated prior to receiving the set of detector events and the QEC code is a topological surface code or a color code.

19. The method of claim 1, wherein a first non-decomposable error type of the set of non-decomposable error types is associated with a first error operator, a second non-decomposable error of the set of non-decomposable error types is associated with a second error operation, a first decomposable error type of the set of decomposable error types is associated with a third error operator being composed of a product of the first error operator and the second error operator, and each of the first error operator, the second error operator, and the third error operator is a unitary Hermitian operator.

20. A computing system, comprising:
one or more processor devices;
one or more memory devices, the one or more memory devices storing computer-readable instructions that when executed by the one or more processor devices cause the one or more processor devices to perform operations for decoding qubit errors on a set of qubits that is subject to a set of error types that includes a set of non-decomposable error types and a set of decomposable error types, the operations comprising:
generating an initial matching graph (MG) for a quantum error correction (QEC) code based on the set of non-decomposable error types, wherein the initial MG includes a set of nodes and a set of non-decomposable edges, and wherein each non-decomposable edge of the set of non-decomposable edges is associated with one or more non-decomposable error types of the set of non-decomposable error types occurring on one or more qubits of the set of qubits;
generating a set of decomposable potential-edges for an updated MG based on the set of decomposable error types, wherein each decomposable potential-edge of the set of decomposable potential-edges is associated with one or more decomposable error types of the set of decomposable error types occurring on one or more qubits of the set of qubits; and;
generating the updated MG based on the set of decomposable potential-edges, wherein the updated MG includes the set of nodes and a set of updated edges that includes the set of non-decomposable edges and a set of decomposable edges.
